(19) United States
(12) Patent Application Publication
(10) Pub. No.: US 2025/0309601 A1
(43) Pub. Date: Oct. 2, 2025

(54) BENDING DECELERATION MODULE

(71) Applicant: HanJungNCS.CO., LTD, Yeongcheon-si (KR)

(72) Inventors: Goang Sik MIN, Yeongcheon-si (KR); Jae Gu CHOI, Gyeongju-si (KR); Jae Soo KIM, Gyeongsan-si (KR); Gi Seob LIM, Daegu (KR)

(73) Assignee: HanJungNCS.CO., LTD, Yeongcheon-si (KR)

(21) Appl. No.: 18/940,939

(22) Filed: Nov. 8, 2024

(30) Foreign Application Priority Data
Mar. 29, 2024 (KR) 10-2024-0043328

(51) Int. Cl. H01R 43/16

(52) U.S. Cl. CPC H01R 43/16

(57) ABSTRACT

Proposed is a bending deceleration module which includes a first busbar fixing part configured to fix a busbar and to limit a bending angle of the fixed busbar, and a first pressing bending part configured to press and bend the busbar fixed to the first busbar fixing part and having a gear transmission part to transmit a rotational force for pressing the busbar, with the gear transmission part having a deceleration structure using a gear ratio.

### CROSS REFERENCE TO RELATED APPLICATION

The present application claims priority to Korean Patent Application No. 10-2024-0043328, filed Mar. 29, 2024, the entire contents of which are incorporated herein for all purposes by this reference.

### BACKGROUND OF THE INVENTION

### Field of the Invention

The present disclosure relates to a bending deceleration module capable of minimizing necking that occurs when bending a terminal (a busbar) used in a battery of an electric vehicle.

### Description of the Related Art

A battery terminal (a busbar) is required to have a bent structure to ensure electrical connection between battery modules.

In this case, when the busbar is bent by using a press using a general connecting rod, a high load is quickly applied to the busbar, so there is a problem of necking and shock lines occurring at a curved portion of the busbar.

To solve this problem, a method of gradually increasing the bending angle of the busbar is being used, but there is still the problem with necking and shock lines, and a deep-drawing press that can slowly bend the busbar is very expensive and has a problem with low productivity.

Accordingly, there is an increasing need for the development of a new type of bending device that can bend a busbar at a user-set speed to minimize necking and shock lines, and has a simple structure to have a low manufacturing cost.

### DOCUMENTS OF RELATED ART

(Patent Document 1) Korean Patent No. 10-2639017 (Title: BENDING APPARATUS, registered on Feb. 16, 2024)

(Patent Document 2) Korean Patent Application Publication No. 10-2024-0027947 (Title: 3-PHASE BUSBAR MANUFACTURING METHOD AND 3-PHASE BUSBAR, published on Mar. 5, 2024)

### SUMMARY OF THE INVENTION

Accordingly, the present disclosure has been made keeping in mind the above problems occurring in the related art, and the present disclosure is intended to propose a bending deceleration module that eliminates necking and shock lines that occur in the process of bending a busbar.

In order to achieve the objective of the present disclosure, there is provided a bending deceleration module including: a first busbar fixing part 110 configured to fix a busbar 1 and to limit a bending angle of the fixed busbar 1; and a first pressing bending part 120 configured to press and bend the busbar 1 fixed to the first busbar fixing part 110 and having a gear transmission part to transmit a rotational force for pressing the busbar 1, with the gear transmission part having a deceleration structure using a gear ratio.

In addition, the first busbar fixing part 110 may include: a first lower mold 111 located at a lower side thereof to support the busbar 1; and a first upper mold 112 configured to fix the busbar 1 by pressing an upper surface of the busbar 1 located on the first lower mold 111 and to limit the bending angle of the busbar 1.

In addition, the busbar 1 may include: a horizontal portion 1-1 located on a first longitudinal side thereof; a curved portion 1-2 coupled to a second longitudinal side of the horizontal portion 1-1; and a bending portion 1-3 coupled to a second longitudinal side of the curved portion 1-2 and bent by the first pressing bending part 120, wherein the first upper mold 112 may include a stopper rib 112-1 having a lower surface with a shape corresponding to the curved portion 1-2 to press and fix the curved portion 1-2, and having a side surface formed perpendicularly to the horizontal portion 1-1 to limit a bending angle of the bending portion 1-3.

In addition, the first pressing bending part 120 may include: a bending-part housing 121 coupled to a longitudinal side of the first lower mold 111 and having a gear accommodating recess 121-1 formed therein; a rotational force transmission gear 122 having a circular shape coupled to a first longitudinal side of the gear accommodating recess 121-1; a pressing gear 123 located on a second longitudinal side of the gear accommodating recess 121-1 to rotate by receiving a rotational force from the rotational force transmission gear 122, with the pressing gear 123 having an arc-shaped edge to have a busbar pressing part 123-1 formed on a side surface thereof; and a rack gear 124 coupled vertically movably to a longitudinal side of the bending-part housing 121 and having teeth formed on a surface of the rack gear 124 facing the rotational force transmission gear 122 so that the teeth engage vertically with the rotational force transmission gear 122.

In addition, the bending deceleration module may further include: a gear operating module 125 located on an upper side of the rack gear 124 and configured to move vertically to move the rack gear 124.

In addition, a rotation speed of the rotational force transmission gear 122 may be slower than a vertical movement speed of the rack gear 124.

There is a busbar bending device 1000 including the bending deceleration module, the busbar bending device including: a base plate 200 having a plate shape; a first bending module 300 coupled to the base plate 200 to first bend the bending portion 1-3 of the busbar 1 at 1 degree to 45 degrees by pressing the busbar 1 up and down; a second bending module 400 coupled to the base plate 200 to second bend the bending portion 1-3 of the busbar 1 to 2 to 60 degrees by pressing the busbar 1 up and down, which has been first bent in the first bending module 300; the bending deceleration module 100 configured to third bend the bending portion 1-3 of the busbar 1 to 90 degrees by pushing the bending portion 1-3 of the busbar 1, which has been second bent in the second bending module 400, from a side thereof; a springback compensation module 500 configured to fourth bend the busbar 1 to 91 to 100 degrees by pushing the busbar 1, which has been third bent in the bending deceleration module 100, from the side; and a horizontal alignment module 600 configured to push the busbar 1, which has been fourth bent in the springback compensation module 500, from the side by using a flat member.

In addition, the first bending module 300 may include: a second lower mold 310 located at a lower side thereof to support the busbar 1 and having a first curved portion insertion groove 311 and a first bending portion support protrusion 312; and a second upper mold 320 located at an upper side of the second lower mold 310 to press the upper surface of the busbar 1 located on the second lower mold 310 and having a first pressing protrusion 321 formed to protrude at a position facing the first curved portion insertion groove 311 and a first support protrusion insertion groove 322 formed at a position facing the first bending portion support protrusion 312.

In addition, the second bending module 400 may include: a third lower mold 410 located at a lower side thereof to support the busbar 1 and having a second curved portion insertion groove 411 and a second bending portion support protrusion 412; and a second upper mold 420 located at an upper side of the third lower mold 410 to press the upper surface of the busbar 1 located on the third lower mold 410 and having a second pressing protrusion 421 formed to protrude at a position facing the second curved portion insertion groove 411 and a second support protrusion insertion groove 422 formed at a position facing the second bending portion support protrusion 412.

In addition, the springback compensation module 500 may include a lower module 510 configured to support the busbar 1; a rotating member 520 coupled rotatably to the lower module 510; a first stopper member 530 configured to limit the rotation angle of the rotating member 520; and a cam 540 configured to push the rotating member 520.

In addition, the cam 540 may include a cam body 541 having a bent rib 541-1 formed on a longitudinal side thereof; a stopper bolt 542 coupled to the bent rib 541-1 to limit a longitudinal movement range of the cam body 541; and a cam movement adjustment bolt 543 coupled to the bent rib 541-1 to adjust longitudinal movement of the cam body 541.

In addition, the horizontal alignment module 600 may include a slide movement adjustment means 610 configured to move in a vertical direction and having a first inclined surface 611 formed on a lower side thereof; and a horizontal moving member 620 having a second inclined surface 621 formed on an upper side thereof to correspond to the first inclined surface 611 of the slide movement adjustment means 610 so that the horizontal moving member 620 slides horizontally in response to the vertical movement of the slide movement adjustment means 610, and having a pressing surface 622 formed therein.

In the bending deceleration module of the present disclosure, since the gear transmission part has the deceleration structure, the busbar can be slowly pressed and bent, thereby eliminating the necking and shock lines of the busbar that may occur in a bending process.

In addition, the gear transmission part of the bending deceleration module has a simple structure in which a plurality of gears are coupled to each other, thereby minimizing the manufacturing cost of the bending deceleration module.

Furthermore, the gear ratio of the plurality of gears that constitute the gear transmission part is adjusted, thereby freely adjusting the bending speed of the busbar through the bending deceleration module.

### BRIEF DESCRIPTION OF THE DRAWINGS

The above and other objectives, features, and other advantages of the present disclosure will be more clearly understood from the following detailed description when taken in conjunction with the accompanying drawings, in which:

FIGS. 1 and 2 are conceptual views showing a bending deceleration module of the present disclosure;

FIG. 3 is a plan view showing a busbar bending device including the bending deceleration module of the present disclosure;

FIGS. 4A and 4B are conceptual views showing a first bending module and a second bending module of the busbar bending device of the present disclosure;

FIGS. 5A and 5B are conceptual views showing the bending deceleration module and a springback compensation module of the busbar bending device of the present disclosure; and

FIG. 6 is a conceptual view showing a horizontal alignment module of the bending deceleration module of the present disclosure.

### DETAILED DESCRIPTION OF THE INVENTION

Advantages and features of embodiments of the present disclosure and methods for achieving them will become apparent with reference to the embodiments described below in detail together with the accompanying drawings. However, the present disclosure is not limited to the embodiments disclosed below and may be implemented in various different forms. The embodiments are provided only to ensure that the disclosure of the present disclosure is complete and to fully inform those skilled in the art to which the present disclosure belongs of the scope of the present disclosure, and the present disclosure is defined only by the scope of the claims. Throughout the specification, identical reference numerals refer to identical components.

In describing the embodiments of the present disclosure, when it is determined that a detailed description of a known function or configuration may unnecessarily obscure the gist of the present disclosure, the detailed description will be omitted. In addition, terms described below are terms defined in consideration of functions thereof in the embodiments of the present disclosure, and may vary depending on the intention or custom of a user or operator. Therefore, the definitions should be based on contents throughout this specification.

Hereinafter, a bending deceleration module 100 of the present disclosure will be described with reference to the accompanying drawings.

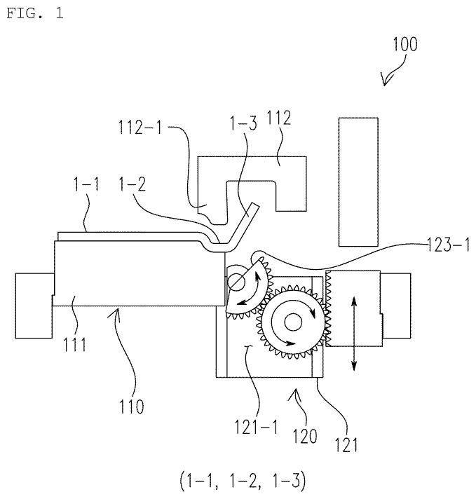

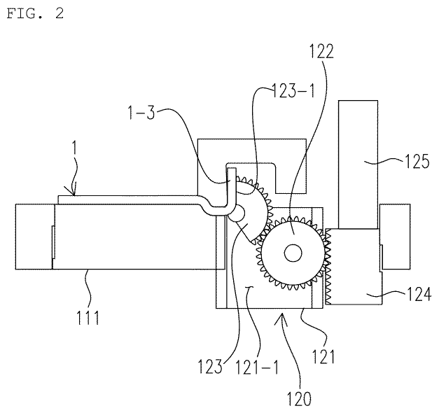

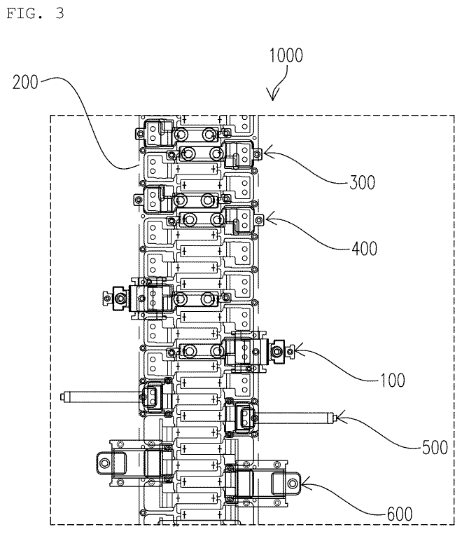

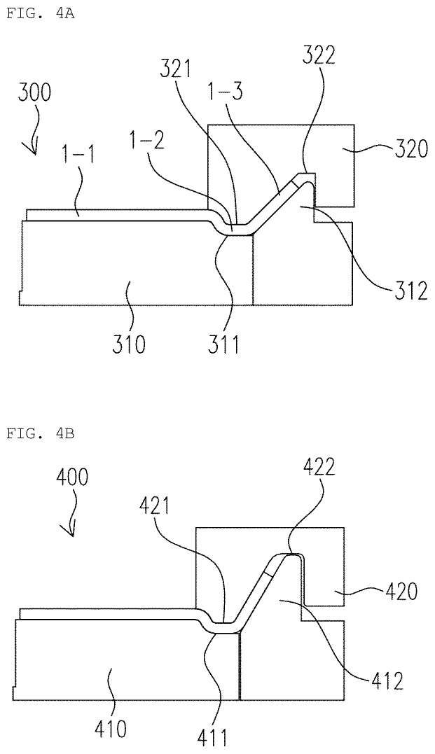

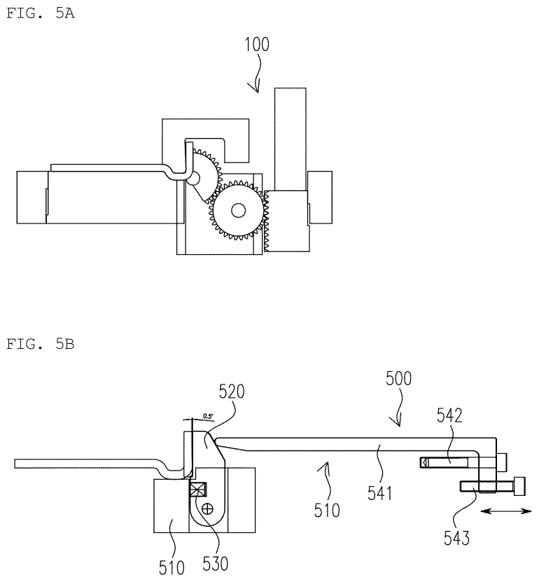

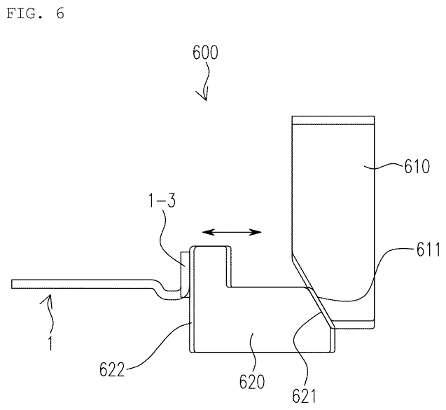

FIGS. 1 and 2 are conceptual views showing a bending deceleration module of the present disclosure; FIG. 3 is a plan view showing a busbar bending device including the bending deceleration module of the present disclosure; FIGS. 4A and 4B are conceptual views showing a first bending module and a second bending module of the busbar bending device of the present disclosure; FIGS. 5A and 5B are conceptual views showing the bending deceleration module and a springback compensation module of the busbar bending device of the present disclosure; and FIG. 6 is a conceptual view showing a horizontal alignment module of the bending deceleration module of the present disclosure.

Referring to FIGS. 1 and 2, the bending deceleration module 100 of the present disclosure may include a first busbar fixing part 110 configured to fix the busbar 1 and to limit a bending angle of the fixed busbar 1, and a first pressing bending part 120 configured to press and bend the busbar 1 fixed to the first busbar fixing part 110 and having a gear transmission part to transmit a rotational force for pressing the busbar 1, with the gear transmission part having a deceleration structure using a gear ratio.

To explain in detail, the deceleration structure allows the busbar 1 to be bent slowly so as to minimize the necking of the busbar 1 that may occur during the bending process.

In this case, the first busbar fixing part 110 may include a first lower mold 111 located at a lower side thereof to support the busbar 1, and a first upper mold 112 configured to fix the busbar 1 by pressing an upper surface of the busbar 1 located on the first lower mold 111 and to limit the bending angle of the busbar 1.

In addition, the busbar 1 may include a horizontal portion 1-1 located on a first longitudinal side thereof, a curved portion 1-2 coupled to a second longitudinal side of the horizontal portion 1-1, and a bending portion 1-3 coupled to a second longitudinal side of the curved portion 1-2 and bent by the first pressing bending part 120. The first upper mold 112 may include a stopper rib 112-1 having a lower surface with a shape corresponding to the curved portion 1-2 to press and fix the curved portion 1-2, and having a side surface formed perpendicularly to the horizontal portion 1-1 to limit a bending angle of the bending portion 1-3.

To explain in detail, the busbar 1 has the horizontal portion 1-1, the curved portion 1-2, and the bending portion 1-3 positioned from the first longitudinal side to the second longitudinal side thereof, and a connection portion between the curved portion 1-2 and the bending portion 1-3 is pressed and the angle of the connection portion is adjusted.

Accordingly, when the stopper rib 112-1 presses the curved portion 1-2 of the busbar 1 located on the first lower mold 111, and the first pressing bending part 120 presses the bending portion 1-3, the connection portion between the curved portion 1-2 and the bending portion 1-3 may be bent.

In addition, the stopper rib 112-1 limits an angle at which the first pressing bending part 120 pushes the bending portion 1-3, so that the bending angle of the bending portion 1-3 may be achieved within a set range.

In this case, the first pressing bending part 120 may include a bending-part housing 121 coupled to a longitudinal side of the first lower mold 111 and having a gear accommodating recess 121-1 formed therein, a rotational force transmission gear 122 having a circular shape coupled to a first longitudinal side of the gear accommodating recess 121-1, a pressing gear 123 located on a second longitudinal side of the gear accommodating recess 121-1 to rotate by receiving a rotational force from the rotational force transmission gear 122, with the pressing gear 123 having an arc-shaped edge to have a busbar pressing part 123-1 formed on a side surface thereof, a rack gear 124 coupled vertically movably to a longitudinal side of the bending-part housing 121 and having teeth formed on a surface of the rack gear 124 facing the rotational force transmission gear 122 so that the teeth engage vertically with the rotational force transmission gear 122, and a gear operating module 125 located on an upper side of the rack gear 124 and configured to move vertically to move the rack gear 124.

To explain in detail, when the rack gear 124 moves upward or downward according to the vertical movement of the gear operating module 125, the rotational force transmission gear 122 rotates in response to the movement of the rack gear 124, and the rotational force transmission gear 122 rotates the pressing gear 123, so that the busbar pressing part 123-1 of the pressing gear 123 presses the lower side of the bending portion 1-3 of the busbar 1.

In this case, it is recommended that a gear ratio between the rotational force transmission gear 122 and the rack gear 124 is set such that the rotational force transmission gear 122 has a higher ratio, resulting in the rotational radius of the rotational force transmission gear 122 being smaller than the vertical movement distance of the rack gear 124.

That is, due to the gear ratio between the rack gear 124 and the rotational force transmission gear 122, the rotation of the rotational force transmission gear 122 is slower than the vertical movement of the rack gear 124.

Furthermore, the rack gear 124 and the rotational force transmission gear 122 need only be capable of reducing speed during the rotational force transmission process, and the gear ratio may be varied according to design of a user.

In addition, although not shown in the drawing, it is recommended that the rack gear 124 is vertically slidably coupled to the bending-part housing 121, and an elastic member for restoring the height of the rack gear 124 is coupled to the lower side of the rack gear 124 so that when the pressing of the gear operating module 125 is completed, the rack gear 124 is restored to a position thereof before the rack gear 124 is pressed.

Referring to FIGS. 3 to 6, a busbar bending device 1000 including the bending deceleration module may include: a base plate 200 having a plate shape; a first bending module 300 coupled to the base plate 200 to first bend the bending portion 1-3 of the busbar 1 at 1 degree to 45 degrees by pressing the busbar 1 up and down; a second bending module 400 coupled to the base plate 200 to second bend the bending portion 1-3 of the busbar 1 to 2 to 60 degrees by pressing the busbar 1 up and down, which has been first bent in the first bending module 300; the bending deceleration module 100 configured to third bend the bending portion 1-3 of the busbar 1 to 90 degrees by pushing the bending portion 1-3 of the busbar 1, which has been second bent in the second bending module 400, from a side thereof; a springback compensation module 500 configured to fourth bend the busbar 1 to 91 to 100 degrees by pushing the busbar 1, which has been third bent in the bending deceleration module 100, from the side; and a horizontal alignment module 600 configured to push the busbar 1, which has been fourth bent in the springback compensation module 500, from the side by using a flat member.

To explain in detail, a plurality of modules for adjusting the angle of the busbar 1 are combined on the base plate 200 so that the angle of the busbar 1 may be adjusted gradually as the busbar 1 moves over the busbar bending device 1000.

In this case, although not shown in the drawing, the busbar bending device 1000 may further include a transport means of the busbar 1 to move the busbar 1 sequentially to a plurality of modules coupled to the base plate 200.

Referring to FIG. 4A, the first bending module 300 may include: a second lower mold 310 located at a lower side thereof to support the busbar 1 and having a first curved portion insertion groove 311 and a first bending portion support protrusion 312; and a second upper mold 320 located at an upper side of the second lower mold 310 to press the upper surface of the busbar 1 located on the second lower mold 310 and having a first pressing protrusion 321 formed to protrude at a position facing the first curved portion insertion groove 311 and a first support protrusion insertion groove 322 formed at a position facing the first bending portion support protrusion 312.

To explain in detail, the first pressing protrusion 321 presses the busbar 1 in a horizontal state to form the curved portion 1-2 in the busbar 1, and the first support protrusion insertion groove 322 presses the busbar 1 so that the bending portion 1-3 of the busbar 1 pressed by the first bending portion support protrusion 312 and the first support protrusion insertion groove 322 can be first bent at 45 degrees.

In addition, referring to FIG. 4B, the second bending module 400 may include a third lower mold 410 located at a lower side thereof to support the busbar 1 and having a second curved portion insertion groove 411 and a second bending portion support protrusion 412; and a second upper mold 420 located at an upper side of the third lower mold 410 to press the upper surface of the busbar 1 located on the third lower mold 410 and having a second pressing protrusion 421 formed to protrude at a position facing the second curved portion insertion groove 411 and a second support protrusion insertion groove 422 formed at a position facing the second bending portion support protrusion 412.

That is, the busbar 1 having the bending portion 1-3 bent at 45 degrees in the first bending module 300 may be bent a second time to 60 degrees by pressing of the third lower mold 410 and the second upper mold 420 in the second bending module 400.

In addition, the bending portion 1-3 of the busbar 1, which is bent to 60 degrees in the second bending module 400, is bent at a low speed to 90 degrees.

In addition, even if the bending portion 1-3 is bent to 90 degrees through the pressing and bending, there is a problem in that the bending portion 1-3 is restored to 80 to 89 degrees due to springback. Therefore, in the springback compensation module 500, the busbar 1 is bent to 90 degrees or more so that the angle of the bending portion 1-3 can be 90 degrees.

In this case, the springback compensation module 500 may include a lower module 510 configured to support the busbar 1, a rotating member 520 coupled rotatably to the lower module 510, a first stopper member 530 configured to limit the rotation angle of the rotating member 520, and a cam 540 configured to push the rotating member 520.

That is, when a user pushes the rotating member 520 by using the cam 540, the rotating member 520 may rotate within an angle limited by the first stopper member 530.

In addition, the cam 540 may include a cam body 541 having a bent rib 541-1 formed on a longitudinal side thereof; a stopper bolt 542 coupled to the bent rib 541-1 to limit a longitudinal movement range of the cam body 541; and a cam movement adjustment bolt 543 coupled to the bent rib 541-1 to adjust longitudinal movement of the cam body 541.

Referring to FIG. 6, the horizontal alignment module 600 pushes the bending portion 1-3 by a flat surface thereof so that the bending portion 1-3 does not bend and remains vertical in a vertical direction.

In this case, the horizontal alignment module 600 may include a slide movement adjustment means 610 configured to move in a vertical direction and having a first inclined surface 611 formed on a lower side thereof; and a horizontal moving member 620 having a second inclined surface 621 formed on an upper side thereof to correspond to the first inclined surface 611 of the slide movement adjustment means 610 so that the horizontal moving member 620 slides horizontally in response to the vertical movement of the slide movement adjustment means 610, and having a pressing surface 622 formed on a left side of the horizontal moving member 620.

The present disclosure is not limited to the above-described embodiments, and is broad in the scope of application. Those skilled in the art may make various modifications without departing from the gist of the present disclosure claimed in the claims.

What is claimed is:

1. A bending deceleration module comprising:
a first busbar fixing part (110) configured to fix a busbar (1) and to limit a bending angle of the fixed busbar (1); and
a first pressing bending part (120) configured to press and bend the busbar (1) fixed to the first busbar fixing part (110) and having a gear transmission part to transmit a rotational force for pressing the busbar (1), with the gear transmission part having a deceleration structure using a gear ratio.

2. The bending deceleration module of claim 1, wherein the first busbar fixing part (110) includes:
a first lower mold (111) located at a lower side thereof to support the busbar (1); and
a first upper mold (112) configured to fix the busbar (1) by pressing an upper surface of the busbar (1) located on the first lower mold (111) and to limit the bending angle of the busbar (1).

3. The bending deceleration module of claim 2, wherein the busbar (1) includes:
a horizontal portion (1-1) located on a first longitudinal side thereof;
a curved portion (1-2) coupled to a second longitudinal side of the horizontal portion (1-1); and
a bending portion (1-3) coupled to a second longitudinal side of the curved portion (1-2) and bent by the first pressing bending part (120),
wherein the first upper mold (112) includes a stopper rib (112-1) having a lower surface with a shape corresponding to the curved portion (1-2) to press and fix the curved portion (1-2), and having a side surface formed perpendicularly to the horizontal portion (1-1) to limit a bending angle of the bending portion (1-3).

4. The bending deceleration module of claim 2, wherein the first pressing bending part (120) includes:
a bending-part housing (121) coupled to a longitudinal side of the first lower mold (111) and having a gear accommodating recess (121-1) formed therein;
a rotational force transmission gear (122) having a circular shape coupled to a first longitudinal side of the gear accommodating recess (121-1);
a pressing gear (123) located on a second longitudinal side of the gear accommodating recess (121-1) to rotate by receiving a rotational force from the rotational force transmission gear (122), with the pressing gear (123) having an arc-shaped edge to have a busbar pressing part (123-1) formed on a side surface thereof; and
a rack gear (124) coupled vertically movably to a longitudinal side of the bending-part housing (121) and having teeth formed on a surface of the rack gear (124) facing the rotational force transmission gear (122) so that the teeth engage vertically with the rotational force transmission gear (122).

5. The bending deceleration module of claim 4, further comprising:
a gear operating module (125) located on an upper side of the rack gear (124) and configured to move vertically to move the rack gear (124).

6. The bending deceleration module of claim 4, wherein a rotation speed of the rotational force transmission gear (122) is slower than a vertical movement speed of the rack gear (124).

7. A busbar bending device (1000) including the bending deceleration module of claim 1, the busbar bending device comprising:
a base plate (200) having a plate shape;
a first bending module (300) coupled to the base plate (200) to first bend the bending portion (1-3) of the busbar (1) at 1 degree to 45 degrees by pressing the busbar (1) up and down;
a second bending module (400) coupled to the base plate (200) to second bend the bending portion (1-3) of the busbar (1) to 2 to 60 degrees by pressing the busbar (1) up and down, which has been first bent in the first bending module (300);
the bending deceleration module (100) configured to third bend the bending portion (1-3) of the busbar (1) to 90 degrees by pushing the bending portion (1-3) of the busbar (1), which has been second bent in the second bending module (400), from a side thereof;
a springback compensation module (500) configured to fourth bend the busbar (1) to 91 to 100 degrees by pushing the busbar (1), which has been third bent in the bending deceleration module (100), from the side; and
a horizontal alignment module (600) configured to push the busbar (1), which has been fourth bent in the springback compensation module (500), from the side by using a flat member.

8. The busbar bending device of claim 7, wherein the first bending module (300) includes:
a second lower mold (310) located at a lower side thereof to support the busbar (1) and having a first curved portion insertion groove (311) and a first bending portion support protrusion (312); and
a second upper mold (320) located at an upper side of the second lower mold (310) to press the upper surface of the busbar (1) located on the second lower mold (310) and having a first pressing protrusion (321) formed to protrude at a position facing the first curved portion insertion groove (311) and a first support protrusion insertion groove (322) formed at a position facing the first bending portion support protrusion (312).

9. The busbar bending device of claim 7, wherein the second bending module (400) includes:
a third lower mold (410) located at a lower side thereof to support the busbar (1) and having a second curved portion insertion groove (411) and a second bending portion support protrusion (412); and
a second upper mold (420) located at an upper side of the third lower mold (410) to press the upper surface of the busbar (1) located on the third lower mold (410) and having a second pressing protrusion (421) formed to protrude at a position facing the second curved portion insertion groove (411) and a second support protrusion insertion groove (422) formed at a position facing the second bending portion support protrusion (412).

10. A busbar bending device (1000) including the bending deceleration module of claim 2, the busbar bending device comprising:
a base plate (200) having a plate shape;
a first bending module (300) coupled to the base plate (200) to first bend the bending portion (1-3) of the busbar (1) at 1 degree to 45 degrees by pressing the busbar (1) up and down;
a second bending module (400) coupled to the base plate (200) to second bend the bending portion (1-3) of the busbar (1) to 2 to 60 degrees by pressing the busbar (1) up and down, which has been first bent in the first bending module (300);
the bending deceleration module (100) configured to third bend the bending portion (1-3) of the busbar (1) to 90 degrees by pushing the bending portion (1-3) of the busbar (1), which has been second bent in the second bending module (400), from a side thereof;
a springback compensation module (500) configured to fourth bend the busbar (1) to 91 to 100 degrees by pushing the busbar (1), which has been third bent in the bending deceleration module (100), from the side; and
a horizontal alignment module (600) configured to push the busbar (1), which has been fourth bent in the springback compensation module (500), from the side by using a flat member.

11. A busbar bending device (1000) including the bending deceleration module of claim 3, the busbar bending device comprising:
a base plate (200) having a plate shape;
a first bending module (300) coupled to the base plate (200) to first bend the bending portion (1-3) of the busbar (1) at 1 degree to 45 degrees by pressing the busbar (1) up and down;
a second bending module (400) coupled to the base plate (200) to second bend the bending portion (1-3) of the busbar (1) to 2 to 60 degrees by pressing the busbar (1) up and down, which has been first bent in the first bending module (300);
the bending deceleration module (100) configured to third bend the bending portion (1-3) of the busbar (1) to 90 degrees by pushing the bending portion (1-3) of the busbar (1), which has been second bent in the second bending module (400), from a side thereof;
a springback compensation module (500) configured to fourth bend the busbar (1) to 91 to 100 degrees by pushing the busbar (1), which has been third bent in the bending deceleration module (100), from the side; and
a horizontal alignment module (600) configured to push the busbar (1), which has been fourth bent in the springback compensation module (500), from the side by using a flat member.

12. A busbar bending device (1000) including the bending deceleration module of claim 4, the busbar bending device comprising:
a base plate (200) having a plate shape;
a first bending module (300) coupled to the base plate (200) to first bend the bending portion (1-3) of the busbar (1) at 1 degree to 45 degrees by pressing the busbar (1) up and down;
a second bending module (400) coupled to the base plate (200) to second bend the bending portion (1-3) of the busbar (1) to 2 to 60 degrees by pressing the busbar (1) up and down, which has been first bent in the first bending module (300);
the bending deceleration module (100) configured to third bend the bending portion (1-3) of the busbar (1) to 90 degrees by pushing the bending portion (1-3) of the busbar (1), which has been second bent in the second bending module (400), from a side thereof;
a springback compensation module (500) configured to fourth bend the busbar (1) to 91 to 100 degrees by pushing the busbar (1), which has been third bent in the bending deceleration module (100), from the side; and
a horizontal alignment module (600) configured to push the busbar (1), which has been fourth bent in the springback compensation module (500), from the side by using a flat member.

13. A busbar bending device (1000) including the bending deceleration module of claim 5, the busbar bending device comprising:
a base plate (200) having a plate shape;
a first bending module (300) coupled to the base plate (200) to first bend the bending portion (1-3) of the busbar (1) at 1 degree to 45 degrees by pressing the busbar (1) up and down;
a second bending module (400) coupled to the base plate (200) to second bend the bending portion (1-3) of the busbar (1) to 2 to 60 degrees by pressing the busbar (1) up and down, which has been first bent in the first bending module (300);
the bending deceleration module (100) configured to third bend the bending portion (1-3) of the busbar (1) to 90 degrees by pushing the bending portion (1-3) of the busbar (1), which has been second bent in the second bending module (400), from a side thereof;
a springback compensation module (500) configured to fourth bend the busbar (1) to 91 to 100 degrees by pushing the busbar (1), which has been third bent in the bending deceleration module (100), from the side; and
a horizontal alignment module (600) configured to push the busbar (1), which has been fourth bent in the springback compensation module (500), from the side by using a flat member.

14. A busbar bending device (1000) including the bending deceleration module of claim 6, the busbar bending device comprising:
a base plate (200) having a plate shape;
a first bending module (300) coupled to the base plate (200) to first bend the bending portion (1-3) of the busbar (1) at 1 degree to 45 degrees by pressing the busbar (1) up and down;
a second bending module (400) coupled to the base plate (200) to second bend the bending portion (1-3) of the busbar (1) to 2 to 60 degrees by pressing the busbar (1) up and down, which has been first bent in the first bending module (300);
the bending deceleration module (100) configured to third bend the bending portion (1-3) of the busbar (1) to 90 degrees by pushing the bending portion (1-3) of the busbar (1), which has been second bent in the second bending module (400), from a side thereof;
a springback compensation module (500) configured to fourth bend the busbar (1) to 91 to 100 degrees by pushing the busbar (1), which has been third bent in the bending deceleration module (100), from the side; and
a horizontal alignment module (600) configured to push the busbar (1), which has been fourth bent in the springback compensation module (500), from the side by using a flat member.
